(19) United States
(12) Patent Application Publication
(10) Pub. No.: US 2008/0219326 A1
(43) Pub. Date: Sep. 11, 2008

(54) Wireless multimedia link

(76) Inventor: John Santhoff, Carlsbad, CA (US)

Correspondence Address: PULSE-LINK, INC., 1969 KELLOGG AVENUE, CARLSBAD, CA, 92008, US

(21) Appl. No.: 11/716,259

(22) Filed: Mar. 9, 2007

(51) Int. Cl. H04B 1/00

(52) U.S. Cl. 375/141; 375/E01.002

(57) ABSTRACT

An apparatus with a first information decoder (103) and an information encoder (104) operates in at least one of a lossless and a lossy encoding modes to re-encode original information decoded by the first information decoder (103). A transmitter (105) is coupled to the information encoder (104) and to at least one receiver (112) which is coupled to a second information decoder (113). The second information decoder (113) operates in the at least one of the lossless and the lossy decoding modes to recover information substantially representing content associated with the original information.

### FIELD OF THE INVENTION

This invention relates in general to Communications Systems and more particularly to a communication system that transports multimedia on a wire or wireless link.

### BACKGROUND OF THE INVENTION

In conventional wireless indications systems, information is communicated between a transmitter and receiver. This operation is commonly referred to as half duplex operation, where information is communicated only in a single direction over a communication link. With the need for more advanced control mechanisms, including the negotiation of communication link parameters, and the recognition of receiving device characteristics for rendering content, full duplex systems have become the desired architecture for use in today's modern consumer electronic devices. Simply, in a full duplex system, information may be simultaneously communicated in both directions, enabling more sophisticated error correction capabilities and ensuring the highest quality of service relating to be delivered information.

Recently, several attempts have been made to build systems for consumer use that transports both high fidelity and multi-channel audio and high quality and high definition video using wireless protocols such as IEEE 802.11 and its variations. After several companies built and deployed such systems, customers almost completely rejected the implementations because IEEE 802.11 in its present form does not support quality of service for applications such as streaming audio or video. Moreover, the intrinsic system architecture of an IEEE 802.11 network comprises a central node known as an access point, and connecting devices known as stations. Normally, an IEEE 802.11 system operates in an infrastructure mode rather than an ad hock mode. In the infrastructure operating mode, the IEEE 802.11 system routes all traffic between stations through the access point. From a performance standpoint, the access point acts as a bottleneck because it must share processing bandwidth between each connected station and typically a single wired network connection.

Although IEEE 802.11 systems may operate in what is known as the ad hock mode, this is typically not used for communication between stations because of its lack of security, and difficulty in configuration. Moreover, ad hoc IEEE 802.11 systems may unknowingly interfere with IEEE 802.11 systems operating in the infrastructure mode. Therefore, a better solution is needed for the wired and wireless communication of multimedia information between respective components in today's multimedia entertainment systems.

In a 2002 landmark decision, the United States Federal Communications Commission approved the operation of devices using technology known as ultra-wideband. This ultra-wideband technology carries with it the promise of using over 7 GHz of radio spectrum to robustly communicate high-speed information. Such a technology forms the basis as an enabler for applications such as real-time streaming of both standard- and high-definition television, as well as multi-channel audio.

Recognizing the potential of this new ultra-wideband technology, the IEEE, with relevant inputs from industry leaders, authorized a project for high-speed personal area networks. That project resulted in two issued standards, designated IEEE 802.15.3-2003 and IEEE Std 802.15.3b™-2005. These two standards were specifically designed to support high-speed communication between wireless devices in an organized network. Furthermore, the above IEEE standards support isochronous data communication which is essential in applications where information representing for instance, continuous audio or video playback, is communicated from a source device to its target. Examples of typical source devices are DVD players, audio CD players, digital set-top boxes used in cable and satellite communications, or possibly a digital media server. Similarly, examples of target devices are multichannel audio amplifiers, video monitors such as LCD, plasma, or DLP™ display devices, or powered digital multichannel speakers.

The IEEE, by creating the standards, has provided an enabler for the consumer electronics industry to develop products that operate using proprietary ultra-wideband implementations as the PHY or physical layer (commonly known as layer 1) in conjunction with the IEEE 802.15.3 defined MAC layer (commonly known as layer 2), resulting in a full duplex communication system capable of effectively delivering wireless multimedia content in typical home and office environments.

Consequently, if a communication system is implemented using one of the IEEE 802.15.3 MAC layers, a suitable ultra-wideband PHY layer, along with appropriate DEV HOST support, one may be able to communicate digitally encoded multimedia content.

However, conventional digital transport protocols and encoding techniques such as the discrete cosine transform (DCT) based MPEG-2 (Motion Picture Experts Group) coding scheme which is used in the majority of conventional digital video rendering devices today, require extremely low channel bit error rates in order to maintain a watchable digital picture. When the channel bit error rate and an MPEG-2 based system exceeds a critical threshold, the picture being rendered pixelates in large blocking patterns that correspond to the original MPEG-2 encoding matrix and transform. As the bit error rate rises further, small random regions of pixelation turn into large blocking patterns that completely obscure the relevant information attempting to be communicated and reconstructed by the MPEG-2 decoder. Eventually, most MPEG-2 decoders, after reaching a bit error rate of approximately 10-6, will completely turn off their rendering output and substitute a solid color screen indicating that no recoverable information can be processed.

Therefore, one cannot just build an IEEE 802.15.3 compliant MAC and selected PHY radio and expect the resulting system to perfectly communicate any encapsulated protocol and encoding scheme without error. Steps need to be taken that ensure the integrity of the transported information in its application space, as well as over a wired or wireless channel. In the previous paragraph, a case was illustrated with respect to MPEG-2 coded information that shows the rapid nonlinear breakdown associated with increasing information bit error rates.

Thus, what is needed, is a system that takes advantage of a communication system including a well-designed MAC and PHY, as well as a judiciously chosen information encoding scheme that optimally and effectively protects the information content being communicated, preferably degrading in a linear fashion as with conventional legacy analog systems, as measured by the ability of a target device to properly render the content without the undesirable dramatic degradation seen in today's DCT based digital communication systems.

### BRIEF DESCRIPTION OF THE DRAWINGS

FIG. 1 is a block diagram of a wireless communication system according to a preferred embodiment of the present invention.

FIG. 2 is a block diagram of a physically connected communication system according to a preferred embodiment of the present invention.

FIG. 3 is a diagram of a first information signal decoder according to a preferred embodiment of the present invention.

FIG. 4 is a diagram of the first information signal decoder according to a preferred embodiment of the present invention.

FIG. 5 is a diagram of a second information signal encoder according to a preferred embodiment of the present invention.

FIG. 6 is a diagram of the second information signal encoder according to a preferred embodiment of the present invention.

### DESCRIPTION OF A PREFERRED EMBODIMENT

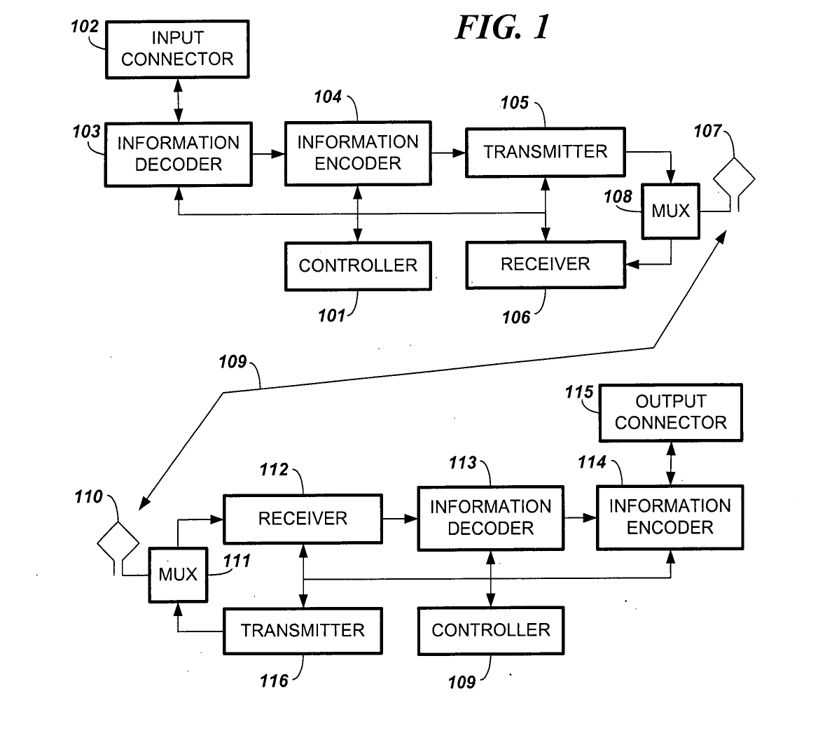

Referring to FIG. 1, a block diagram shows a wireless communication system according to a preferred embodiment of the present invention. Input connector 102 is coupled to a first information decoder 103 that may decode either analog or digital information. Input connector 102 can be selected from any available connector such as a phono plug, RCA jack, S-video, component video, analog RGB, digital RGB, DVI (Digital video interface), high definition multimedia interface (HDMI®), Ethernet IEEE 802.3, Firewire® IEEE 1394, universal serial bus (USB), “F” connector, fiber termination, or any other connector, or media termination, suitable for coupling information for communication. The first information decoder 103 both receives and decodes information into a form that can be coupled to the information encoder 104.

The information decoder 103 further may comprise elements necessary to implement control of signaling passed by a physical media coupled to the input connector 102. For example, it is conventional to use standardized input connectors that relate directly to selected physical media and corresponding digital or analog signaling schemes. It is well understood that wired cables terminating with S-video connectors are used to communicate electrical signals that correspond with S-video content. Similarly, HDMI®, FireWire® or Ethernet specified cables are terminated with uniquely designed connectors that will only allow connections with systems having compatible signaling schemes. Therefore, there can be said that a one-to-one correspondence exists between a specific input connector 102 and selected first information decoder 103 such that the selected first information decoder 103 implements functions necessary to receive and decode original information.

In a preferred embodiment, the information encoder 104 comprises an encoder that is compliant with digital compression schemes such as the JPEG 2000 motion encoding standard for video. This scheme is based on wavelet compression techniques that when properly implemented may exhibit linear degradation characteristics rather than the abrupt non-linear effects seen in DCT based techniques such as seen in MPEG-2 and MPEG-$ coded content. Alternatively, the information encoder 104 may comprise any digital video or multimedia encoder having properties favorable for the wired or wireless transmission of information with high quality of service. In developing the preferred embodiment of the present invention, many conventional video encoding techniques were investigated. The findings revealed that conventional MPEG-2 and MPEG-4 coded source material experienced distracting and undesirable visual artifacts as information channel error rates increased only slightly. As information channel error rates continue to increase, the MPEG-2 and MPEG-4 decoders created presentation signals that did not resemble the original content because the inherent decoding process reaches a sharp threshold where the codec experiences a complete breakdown and a corresponding catastrophic decoding failure. This phenomena is due to the transform process associated with implementation of the discrete cosine transform used in MPEG coding, and the fact that in MPEG coding only one of several frames are completely captured and independently coded, with intervening frames depending on the prior independently coded frame. Therefore, if an error occurs that significantly degrades the quality of the prior independently coded frame, all succeeding frames referenced from the corrupted independently coded frame will be negatively affected. Accordingly, it was determined that in the mid-to low signal-to-noise channel environments, MPEG coding is not desirable for wireless signal distribution. Essentially, choosing the wrong digital video coding scheme results in a binary event from the user perspective, that is, either the current rendition looks perfectly like the original source, or there is significant degradation or no rendition at all.

Additionally, the information encoder 104 may comprise an audio processor capable of logically channelizing one or more channels of audio information. If the received audio information is analog, it must be encoded in an acceptable digital format such as monaural or stereo pulse code modulation, one of the many Dolb® multichannel audio formats, or Digital Theater Systems DTS® multichannel audio formats. Note that one of ordinary skill in the art will appreciate that there are many other methods for encoding digital audio in both single- and multi-channel applications that may be used in conjunction with the present invention. As one or ordinary skill in the art would further appreciate, if the received information is already in an acceptable digital format, no re-encoding is required and it may be passed to the information encoder 104 in it's native digital format for insertion in an encoded data stream for transmission.

Once the information has been encoded by the information encoder 104, an encoded data signal is coupled to the transmitter 105 for transmission. Note that in the simplest embodiment of the present invention, the only elements required to implement the essential features of this invention are the first information decoder 103, the information encoder 104, transmitter 105, a transmission path 109, at least one receiver 112, and a second information decoder 113.

In the preferred embodiment of the present invention, a controller 101 operates to selectively activate and deactivate system elements such as the information decoder 103, information encoder 104, transmitter 105, and receiver 106 to conserve system power when necessary. Moreover, the controller functions to manage interactions between system elements such as the information decoder 103, information encoder 104, transmitter 105, and receiver 106.

Most importantly, each respective controller 101, 109 implements media access control (MAC) architecture that comprises a set of operating rules which govern operation of the respective transmitter 105, 116 and receiver 106, 112 elements, such that either a uni- or bi-directional communication link can be established. There are several MAC architectures that may be used to implement this preferred embodiment of the present invention which are discussed in the following text.

A first embodiment of a MAC can be implemented using IEEE Std 802.15.3b™-2005 which defines a MAC architecture comprising time division multiple access (TDMA) communication slots that are assigned in a manner such that all devices (DEVs) in a piconet can have assured quality of service based on virtual communication medium reservation. IEEE Std 802.15.3b™-2005 implements an isochronous transport mechanism since it guarantees delivery of synchronized multimedia streams comprising video and multichannel audio. This particular MAC implementation shall be referred to as a TDMA-ISO PAN MAC. A second embodiment of a MAC can be implemented using IEEE 1394 and it's progeny as well as enhancements derived from the 1394 Trade Association (1394TA) which include a high-speed serial MAC architecture comprising time division multiple access communication slots, isochronous data transport, and industry accepted digital rights management features. This particular MAC implementation shall be referred to as a 1394-ISO MAC.

A third embodiment of a MAC can be implemented using the ECMA-368 standard, which describes the low-level basis for WiMedia™ compliant devices. ECMA-368 defines a MAC architecture comprising time division multiple access (TDMA) communication slots that are assigned in a manner such that devices in a piconet can communicate. ECMA-368 additionally creates a distributed control architecture that under certain conditions allows devices other than a piconet controller to assign TDMA timeslots and generally configure device operation in the network. The WiMedia™ Alliance has chosen ECMA-368 as the layer 1, layer 2 enabler for their industry specified communication platform. The WiMedia™ specification adds selected higher layer functionality to the ECMA-368 standard communication device, as well as protocol adaptation layer stacks, to implement personal area network communication devices. Although the ECMA-368—WiMedia™ platform as designed was generally targeted for personal computer applications, e.g., wireless USB or other asynchronous serial communication applications, the present invention specifically contemplates that this solution may be used in it's current form, or possibly adapted/redesigned to include isochronous delivery features such as found in IEEE Std 802.15.3b™-2005. Any of the ECMA-368—WiMedia™ based MAC implementations shall be referred to as a TDMA-ECMA PAN MAC.

A fourth embodiment of a MAC can be implemented using the high throughput amendment for IEEE Std 802.11-1999 commonly known as 802.11n. The 802.11n amendment defines a MAC architecture comprising time division multiple access (TDMA) communication slots that are assigned in a manner such that all capable stations (STAS) in a wireless local area network can participate in a high data throughput network. This MAC implementation may also incorporate enhancements set forth in IEEE 802.11e which address quality of service for information delivery, as well as other enhancements such as privacy and security. This particular MAC implementation shall be referred to as an IEEE 802.11n MAC.

One of ordinary skill in the art will appreciate that other media access control methods may be used in conjunction with the present invention without the loss of performance or features necessary for operation. As with all multimedia transport mechanisms, the key attributes are timely, synchronized delivery of information components comprising video and audio, as well as other related content. Therefore, any delivery mechanism that can facilitate time aligned scheduling and delivery of the preceding information components may be substituted for one of the preceding media access control and corresponding information delivery mechanisms.

In a wireless implementation of the preferred embodiment of the present invention, wireless signals 109 are coupled between source and destination devices via antennas 107, 110. The source antenna 107 is coupled to the output of transmitter 105, receiver 106, via a multiplexer (MUX) 108, and the destination antenna 110 is coupled to the receiver 112, transmitter 116, via a multiplexer (MUX) 111. The multiplexers 108, 111 may be static radio frequency isolation components, conventional transmit/receive switches, or any means necessary to allow effective operation of a half or full duplex communication link. One of ordinary skill in the art will also appreciate that in a real-world implementation of the communication system described in reference to FIG. 1, each of the transmitter 105, receiver 106, at least one transmitter 116, and at least one receiver 112, may further comprise digital error coding, detection, and correction components. Accordingly, digital signals can be communicated either without error or at acceptably low error rate. Examples of such error detection and correction components are structures such as a Viterbi codecs, turbo-codecs, BCH codecs, or low density parity check codecs. The error correction and detection techniques implemented by the preceding components are generally referred to as forward error correction. This list is by no means exhaustive, but gives several practical examples of codecs which may be used. One of the unique aspects of the present invention is the ability to use multiple forward error correction schemes, each one being selected based on the error characteristics of the communication medium. For instance, in a wireless communication system over a very short distance, the effective communication channel error rate is typically very low. Therefore, a forward error correcting code would be used that includes few parity bits, and many data bits. In certain circumstances, the error correction may be completely disabled if the channel is substantially error free. Moreover, depending on the type of information being communicated and the character of the application, e.g., real time high definition video and multichannel audio versus low level control information, a more robust forward error correction would be applied. Accordingly, by adapting the forward error correction based on channel medium, intrinsic and dynamic channel error rates, and application, the present invention operates at a significantly higher efficiency in terms of processing demands as compared to prior art systems that statically determine an applied forward error correction code.

Preferably, the radio portions comprising transmitter 105, receiver 106, the at least one transmitter 116, the at least one receiver 112, and their corresponding antennas 107, 110 are implemented for use with broadband or ultra wideband technology. Conventional broadband techniques include technologies such as IEEE 802.11 wired local area network (WLAN) or IEEE 802.16 wireless metropolitan area networks (WMAN). Ultra wideband techniques may include conventional pulse based radios utilizing any number of basic modulation schemes such as BPSK, direct sequence CDMA or the like. Additionally, OFDM may be utilized in the variant described by standard ECMA-368 including its updates which describe the technology known as multi-band OFDM.

The antenna 110 couples the encoded data signal via the MUX 111 to the at least one receiver 112 that in turn couples the received encoded data signal to a second information decoder 113. In the preferred embodiment, the second information decoder 113 operates using a JPEG 2000 decoding transform directly corresponding with the JPEG 2000 encoding transform applied by the information encoder 104. In this manner, original information encoded by the information encoder 104 is decoded by the second information decoder 113 to recover information that substantially represents content associated with the original information. The recovered information is then coupled to a second information encoder 114. In the preferred embodiment, the second information encoder 114 may be an analog or digital signal encoder, or both. The selection of the second information encoder 114 would be based on the particular application requirements such as, generating a high quality analog component video output signal along with an optical or coax based multichannel digital audio signal. Alternatively, a digital output may be generated including both video and audio components corresponding to signaling as defined in the high definition multimedia interface specification. Consequently, appropriate output connectors 115 would be coupled between signals generated by the information encoder 114 and external media equipment (not shown).

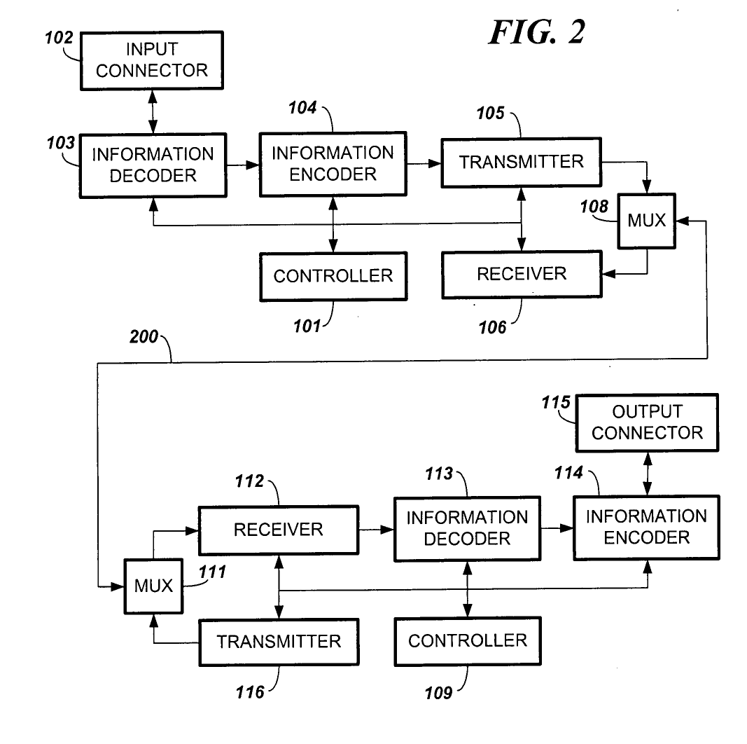

Referring to FIG. 2, a block diagram shows a physically connected communication system according to a preferred embodiment of the present invention.

As with the communication system described in reference to FIG. 1, the communication system operates to convey information between a source coupled to an input connector 102 and a destination coupled to an output connector 115. The main difference is that the communication system illustrated in FIG. 2 comprises physical media 200 through which the encoded data stream is communicated. Examples of acceptable physical media include but are not limited to electrical conductors and light conductors such as single or multimode fiber-optic cable. Conventional electrical conductors may include twisted copper pair, coaxial cable, twin lead, or transmission lines such as conventional electrical wiring.

Thus, the same advantages discussed in reference to FIG. 1, robust operation in low signal to noise environments and increased immunity to interference, are realized in this alternative physically connected communication system.

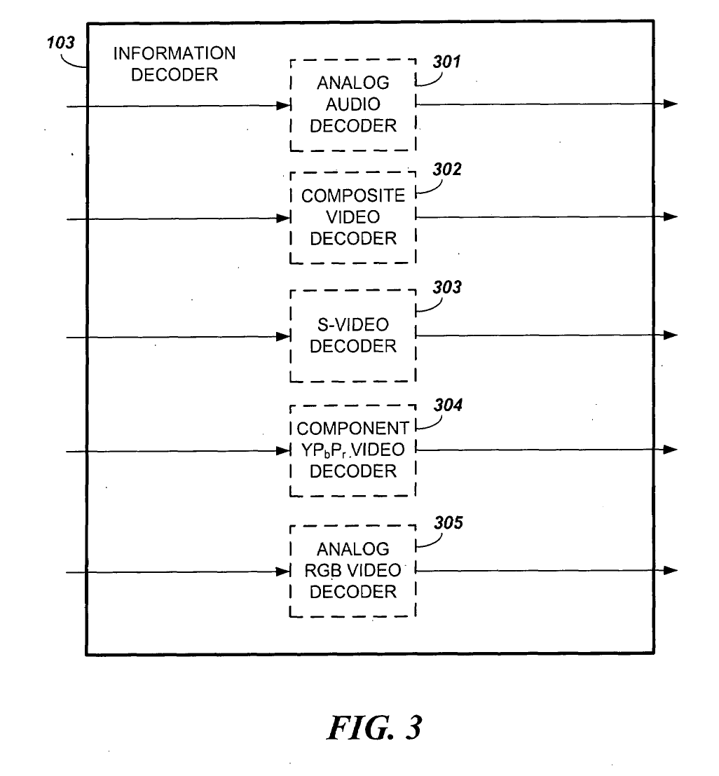

Referring to FIG. 3, a diagram shows the first information decoder 103 according to a preferred embodiment of the present invention. The information decoder 103 comprises any number of the following elements. An analog audio decoder 301, an analog composite video decoder 302, an S-video decoder 303, an analog component video (YP_{b}Pᵣ) decoder 304, and an analog RGB video decoder 305. Additional analog media source type decoders may be added without deviating from the spirit of the present invention.

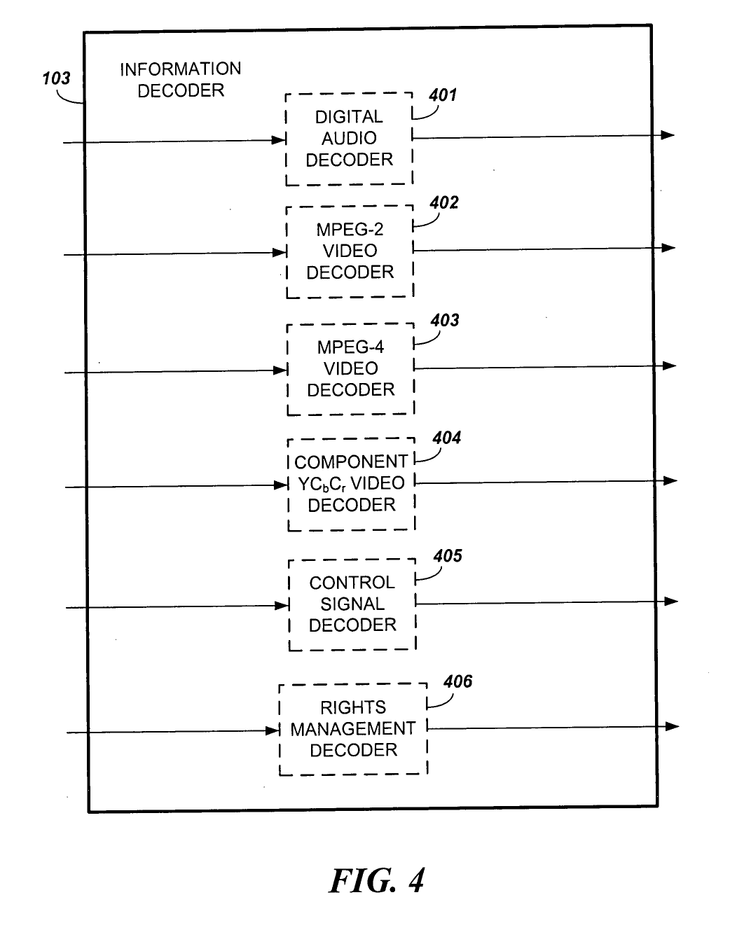

Referring to FIG. 4, a diagram shows the first information decoder 103 according to a preferred embodiment of the present invention. The information decoder 103 comprises any number of the following elements. A digital audio decoder 401, an MPEG-2 video decoder 402, and MPEG-4 video decoder 403, a digital component video (YC_{b}Cᵣ) decoder 404, a control signal decoder 405, and a rights management decoder 406. Additional digital media source type decoders may be added without deviating from the spirit of the present invention.

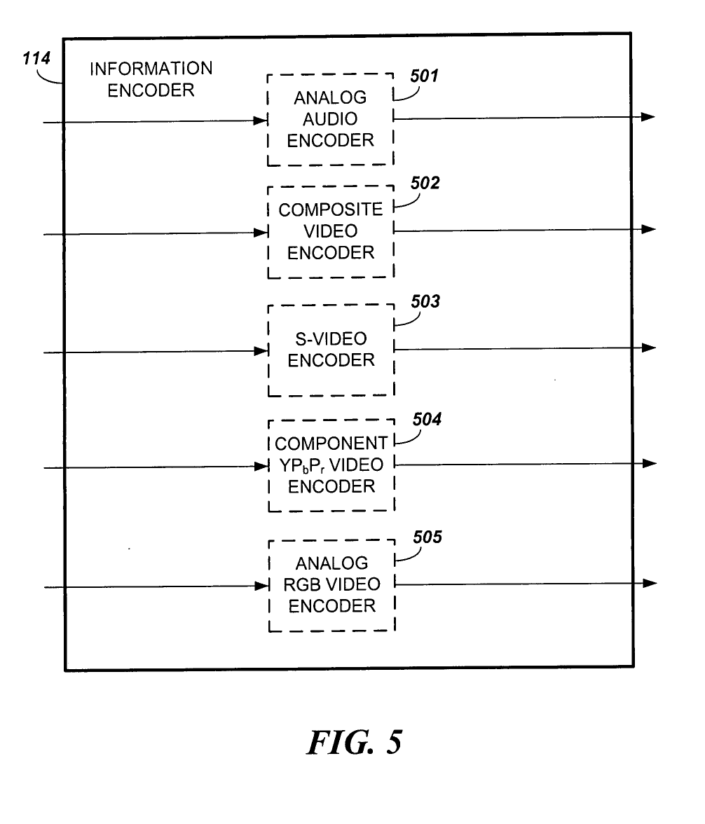

Referring to FIG. 5, a diagram shows the second information encoder 114 according to the preferred embodiment of the present invention. The information encoder 114 comprises any number of the following elements. An analog audio encoder 501, an analog composite video encoder 502, an S-video encoder 503, an analog component video (YP_{b}Pᵣ) encoder 504, and an analog RGB video encoder 505. Additional analog media source type encoders may be added without deviating from the spirit of the present invention.

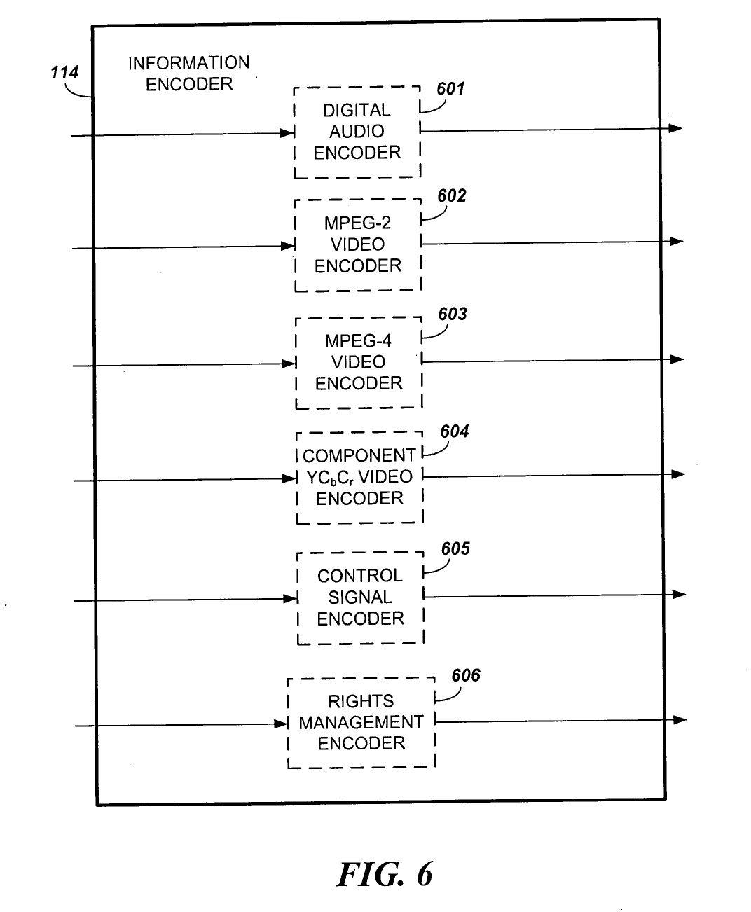

Referring to FIG. 6, a diagram shows the second information encoder 114 according to the preferred embodiment of the present invention. The information encoder 114 comprises any number of the following elements. A digital audio encoder 601, an MPEG-2 video encoder 602, and MPEG-4 video encoder 603, a digital component video (YC_{b}Cᵣ) encoder 604, a control signal encoder 605, and a rights management encoder 606. Additional digital media source type encoders may be added without deviating from the spirit of the present invention.

Regarding operation of the present communication system, media content owners have for several years now required some form of copyright protection, particularly in the case where the original digital information is exposed and susceptible to copying. Their concern is that exact digital copies can be made without the generation to generation loss of presentation quality experienced in prior analog copying schemes. Therefore, industry associations have adopted standards that insure end-to-end security and privacy of the original digital information. These methods are employed in current digital versatile or video (DVD) players and recorders, digital audio tape machines, cable and satellite set top boxes, internet based media delivery services and the corresponding software enablers such as Microsoft Windows® Media Player, Apple Quicktime®, or the like. These hardware and software protection devices and methods are sometimes known as conditional access mechanisms. Their purpose is to allow an authorized user to exercise their rights in the media work according to a license from the content owner, and prevent piracy of the work.

Many of today's wireless media distribution systems use MPEG-2 Layer 3 (commonly known as MP3) coded information to transfer audio media information between a server and a client. The problem is that almost none of the current systems honor any kind of content protection, thus exposing the content owner's work to illegal copying. This problem is particularly aggravated when the information is broadcast since anyone with a receiver in range of the transmitter can receive the transmission. Accordingly, the present invention supports multiple secure mechanisms, each of which that fully comply with the conditional access mechanisms, security, and privacy standards adopted by industry groups that support technologies such as HDMI, cable and satellite television, and digital broadcast radio. Moreover, the present invention also includes the capability to protect media sources transcoded from the analog domain.

Another significant aspect of the present invention is the ability to seamlessly integrate control information in the communicated data stream. This is important since devices such as conventional cable and satellite television set top boxes generate an electronic program guide (EPG) on their high resolution analog output by overlaying graphics while rendering the video for presentation on a local display device. Receiving, decoding and re-encoding this analog signal using motion JPEG 2000 or another suitable codec for wireless transmission is not a problem. However, when media information is in the digital domain as is the case with HDMI delivered high definition television, the problem becomes very difficult if approached using conventional wisdom.

Considering the digital domain case, it is completely impractical to integrate the EPG data into the original digital data stream for several reasons. First, content providers demand and require end-to-end encryption, without intermediate decryption of the underlying coded video and audio. If an attempt was made to integrate EPG data into the video data, it would necessarily require complete recovery of the underlying digital video information. Second, even if the underlying video data was recovered, and the EPG data was inserted, the complete video stream would need to be re-encoded using the native codec (usually MPEG-2) and re-encrypted. Such a process is extremely processor and memory intensive, requires multiple passes for studio quality coding, and is presently completely impractical from both a device and cost standpoint. Moreover, since MPEG-2 is a lossy coding scheme, the resulting product would always have less fidelity when compared to the original information. Another problem is that the MPEG-2 coding process, when applied to graphics with high contrast and sharp transitions, is that the resulting rendered image appears smeared. This is due to the inherent coding matrix applied in MPEG-2. Thus, an EPG overlay that would appear quite sharp if rendered on the bitmap level as video was rendered in a high resolution display device will take on a mushy, smeared appearance if integrated with an existing MPEG-2 content stream.

Another function of the integrated control data channel is to convey commands to both upstream and downstream media components such as digital video recorders, DVD players, audio devices, and of course the display device. In this way, wired or wireless control information can be seamlessly shared throughout a complete multimedia system.

The embodiments of the present invention may be used with narrowband, broadband or ultra-wideband communication technology.

An example of a conventional broadband communication technology is can be found in IEEE 802.11-1999 amendment a, also know as IEEE 802.11a. This is a wireless local area network (LAN) protocol, which transmits a sinusoidal radio frequency signal roughly at a 5 GHz center frequency, with a radio frequency spread of about 20 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (20 MHz) that has a duration that may range from seconds to minutes.

In contrast, an ultra-wideband (UWB) pulse may have a 4.0 GHz center frequency, with a frequency spread of approximately 2 GHz.

Impulse-type ultra-wideband (UWB) communication employs discrete pulses of electromagnetic energy that are emitted at, for example, nanosecond or picosecond intervals (generally tens of picoseconds to a few nanoseconds in duration). For this reason, this type of ultra-wideband is often called “impulse radio.” That is, impulse type UWB pulses may be transmitted without modulation onto a sine wave, or a sinusoidal carrier, in contrast with conventional carrier wave communication technology. Impulse type UWB may operate in virtually any frequency band.

The shorter the UWB pulse is in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate within a specific frequency. UWB pulses may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153).

One generally accepted definition of UWB is that UWB pulses, or signals must occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₗ is the low 10 dB cutoff frequency.

Stated differently, fractional bandwidth is the percentage of a signalls center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₗ)/2

Considering United States ultra-wideband emission limits for indoor systems, UWB communications are constrained to the frequency spectrum between 3.1 GHz and 10.6 GHz, with intentional emissions to not exceed −41.3 dBm/MHz.

Additionally, the International Telecommunications Union (ITU) is in the process of generating recommendations for UWB communications. In many countries, the regulations adopted for UWB communications will differ from the United States rules definition, but may be similar in nature. For example, the Japanese Ministry of Internal Affairs and Communications (MIC) is currently debating the allowance of UWB in Japan. One proposal allows UWB communications in two frequency bands, one from 3.4 GHz to 4.8 GHz, the other from 7.25 GHz to 10.6 GHz. ITU proposals submitted by the European Conference of Postal and Telecommunications Administration (CEPT) would allow UWB transmission only above 6 GHz. Therefore, the definition of UWB cannot not be limited to specific frequency bands.

A number of ultra-wideband (UWB) wireless communication methods that meet the preceding constraints are currently being deployed. A first UWB communication method proposes to transmit UWB pulses that occupy 500 MHz bands within the 7.5 GHz United States allocation (from 3.1 GHz to 10.6 GHz). In an embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of a UWB communication method, an Inverse Fast Fourier Transform (IFFT) is performed on parallel data to produce 122 carriers, each approximately 4.125 MHz wide. This embodiment, also known as Orthogonal Frequency Division Multiplexing (OFDM), results in a UWB pulse, or signal, that is approximately 506 MHz wide, and has approximately 242-nanosecond duration. It meets the current United States rules for UWB communications because it is an aggregation of many relatively narrow band carriers rather than because of the duration of each pulse. One of ordinary skill in the art will appreciate that the elements of either of the preceding UWB systems may be modified so long as the resulting UWB emission complies with a regional regulations.

Another UWB communication method being developed comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being developed comprises transmitting a sequence of pulses that may be approximately 0.7 nanoseconds or less in duration, and at a chipping rate of approximately 1.4 giga-pulses per second. The pulses are modulated using a Direct-Sequence modulation technique, and is known in the industry as DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Another method of UWB communications comprises transmitting a modulated continuous carrier wave where the frequency occupied by the transmitted signal occupies more than the required 20 percent fractional bandwidth. In this method the continuous carrier wave may be modulated in a time period that creates the frequency band occupancy. For example, if a 4 GHz carrier is modulated using binary phase shift keying (BPSK) with data time periods of 750 picoseconds, the resultant signal may occupy 1.3 GHz of bandwidth around a center frequency of 4 GHz. In this example, the fractional bandwidth is approximately 32.5%. This signal would be considered UWB under the FCC regulation discussed above.

Thus, described above are four different methods of ultra-wideband (UWB) communication. It will be appreciated that the present invention may be employed by any of the above-described UWB methods, or others yet to be developed.

What is claimed is:

1. An apparatus comprising:
a first information decoder;
an information encoder coupled to the first information decoder and operating in a selected at least one of a lossless and a lossy encoding modes that re-encodes original information decoded by the first information decoder;
a transmitter coupled to the information encoder;
at least one receiver coupled with the transmitter; and
a second information decoder coupled to the at least one receiver and operating in at least one of the selected lossless and a lossy decoding modes to recover information that substantially represents content associated with the original information.

2. The apparatus according to claim 1 further comprising:
a receiver associated with the transmitter.

3. The apparatus according to claim 1 further comprising:
at least one transmitter associated with the at least one receiver.

4. The apparatus according to claim 1 wherein coupling between the transmitter and the at least one receiver is achieved using a physical media.

5. The apparatus according to claim 4 wherein the physical media uses at least one of broadcast radio waves, conducted electrical signals; broadcast light signals, and conducted light signals.

6. The apparatus according to claim 4 wherein the physical media is at least one of free space, an electrical conductor, and an optical transmission fiber.

7. The apparatus according to claim 1 wherein the transmitter comprises at least one of a radio frequency transmitter, an optical transmitter, and a fiber optic transmitter.

8. The apparatus according to claim 7 wherein the transmitter operates with at least one of an ultra wideband spectrum and on frequencies above 10.6 GHz.

9. The apparatus according to claim 1 wherein the at least one receiver comprises at least one of a radio frequency receiver, an optical receiver, and a fiber optic receiver.

10. The apparatus according to claim 9 wherein the at least one receiver operates with at least one of an ultra wideband spectrum and on frequencies above 10.6 GHz.

11. The apparatus according to claim 2 wherein the receiver comprises at least one of a radio frequency receiver, an optical receiver, and a fiber optic receiver.

12. The apparatus according to claim 11 wherein the receiver operates with at least one of an ultra wideband spectrum and on frequencies above 10.6 GHz.

13. The apparatus according to claim 3 wherein the at least one transmitter comprises at least one of a radio frequency transmitter, an optical transmitter, and a fiber optic transmitter.

14. The apparatus according to claim 13 wherein the at least one transmitter operates with at least one of an ultra wideband spectrum and on frequencies above 10.6 GHz.

15. The apparatus according to claim 1 wherein the first information decoder comprises at least one of a discrete cosine transform based decoder, an MPEG-2 decoder and an MPEG-4 decoder.

16. The apparatus according to claim 1 wherein the information encoder comprises at least one of a wavelet based encoder and a motion JPEG 2000 encoder.

17. The apparatus according to claim 1 wherein the second information decoder comprises at least one of a wavelet based encoder and a motion JPEG 2000 decoder.

18. The apparatus according to claim 1 wherein the first information decoder is at least one of an analog signal decoder and a digital signal decoder.

19. The apparatus according to claim 18 wherein the analog signal decoder operates to decode at least one of a composite video signal, an S-video signal, a component video signal; and an audio signal.

20. The apparatus according to claim 18 wherein the digital signal decoder comprises at least one of:
An IEEE 1394 compliant device,
a high definition multimedia interface compliant device,
a universal serial bus compliant device, and
an Ethernet compliant device.

21. The apparatus according to claim 18 wherein the digital signal decoder operates to decode at least one of a video signal, an audio signal, a control signal, and a rights management signal.

22. The apparatus according to claim 21 wherein the video signal comprises a digital component video signal.

23. The apparatus according to claim 2 further comprising at least one of:
a TDMA-ISO PAN compliant media access controller,
a 1394-ISO compliant media access controller,
a TDMA-ECMA PAN compliant media access controller, and
an IEEE 802.11n compliant media access controller; coupled to the receiver.

24. The apparatus according to claim 3 further comprising at least one of:
a TDMA-ISO PAN compliant media access controller,
a 1394-ISO compliant media access controller,
a TDMA-ECMA PAN compliant media access controller, and
an IEEE 802.11n compliant media access controller; coupled to the at least one transmitter.

25. The apparatus according to claim 1 further comprising a second information encoder comprising at least one of an analog signal encoder and a digital signal encoder; the second information encoder being coupled to the second information decoder.

26. The apparatus according to claim 25 wherein the analog signal encoder operates to encode at least one of a composite video signal, an S-video signal, a component video signal; and an audio signal.

27. The apparatus according to claim 25 wherein the digital signal encoder operates to encode at least one of a video signal, an audio signal, a control signal, and a rights management signal.

28. The apparatus according to claim 27 wherein the video signal comprises a digital component video signal.

29. The apparatus according to claim 25 wherein the digital signal encoder comprises at least one of:
an IEEE 1394 compliant device,
a high definition multimedia interface compliant device,
a universal serial bus compliant device, and
an Ethernet compliant device.

30. An apparatus comprising:
a first information decoder that decodes original video information;
an information encoder coupled to the first information decoder and operating in a selected at least one of a lossless and a lossy motion JPEG 2000 encoding modes to encode the decoded original video information as a digital video signal;
a transmitter coupled to the information encoder;
a controller coupled to the transmitter, the first information decoder, and the information encoder;
a receiver coupled to the controller;
at least one receiver coupled with the transmitter, the at least one receiver operating to receive the digital video signal broadcast by the transmitter;
a second information decoder coupled to the at least one receiver and operating in the selected at least one of the lossless and the lossy motion JPEG 2000 decoding modes to recover video information that substantially represents content associated with the original video information from the digital video signal;
a second controller coupled to the second information decoder and the at least one receiver; and
at least one transmitter associated with the at least one receiver and coupled to the second controller.
